(19) United States
(12) Patent Application Publication
(10) Pub. No.: US 2007/0196573 A1
(43) Pub. Date: Aug. 23, 2007

(54) Apparatus for treating particles utilizing a flow control device

(76) Inventor: James E. Nevin IV, Lake Worth, FL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/372,696

(22) Filed: Mar. 10, 2006

(30) Foreign Application Priority Data
Feb. 20, 2006 (JP) 10-2005-0020612

(51) Int. Cl. B05D 7/00; B05D 5/00; B05C 5/00

(52) U.S. Cl. 427/212; 427/421.1; 118/303; 118/300

(57) ABSTRACT

An apparatus and method for treating a plurality of particles with a coating. The apparatus includes a feed chute and a diffuser having an angled wall to define a gap between the feed chute and the diffuser. An applicator sprays a coating for treating a plurality of particles and an exit chute captures the treated particles. A flow control device is provided for dynamically adjusting a size of the gap between the feed chute and the diffuser as the particles pass through the gap for ensuring a predetermined flow rate of the particles about the diffuser is maintained.

### BACKGROUND OF THE INVENTION

1. Field of the Invention

The subject invention relates to an apparatus for treating particles and ensuring that the particles maintain a predetermined flow rate.

2. Description of Related Art

The prior art is replete with various methods of applying coatings, typically in a liquid form, to solid particles. Many of these prior art systems use a horizontally rotational chamber or drum where a stream of a liquid coating is applied as the particles roll within the drum. Examples of these drum type systems are disclosed in U.S. Pat. Nos. 5,443,637 and 5,501,874. These drum systems require large amounts of space and energy to operate. Also, these systems can be expensive to construct, maintain and install. Other prior art systems utilize other rotational parts for applying the coating, which can likewise be expensive and are also prone to failure. For example, U.S. Pat. Nos. 4,596,206 and 2,862,511 utilize rotary applicators for applying a liquid coating. As other examples, U.S. Pat. No. 4,275,682 utilizes rotating conical plates for dispersing the liquid coating and U.S. Pat. No. 4,520,754 discloses a device that applies an electrical charge to the particles, which are then coated by a rotational applicator with the coating containing an opposite charge.

In order to avoid the pitfalls with the above designs, the prior art has developed alternative systems, such as shown in U.S. Pat. No. 5,993,903, which minimize the number of moving parts. The '903 patent discloses a device having a number converging and diverging conical cones with a number of spray applicators disposed along a length thereof. The '903 patent also discloses a mechanism for adjusting a relative position of some of the cones. The mechanism includes a nut and bolt arrangement which must be fastened before operation of the device. The '903 patent, however, does not includes a mechanism for ensuring proper flow of particles and to reduce the likelihood of clogging the device.

Accordingly, there remains a need to develop a device with a minimal number of moving parts that efficiently treats a relatively large throughput of particles while ensuring that this throughput is maintained and the device does not become clogged.

### SUMMARY OF THE INVENTION AND ADVANTAGES

The subject invention includes an apparatus for treating a plurality of particles with a coating. The apparatus comprises a feed chute having an inlet for receiving the particles and an outlet for discharging the particles. A diffuser has an angled wall and a base with the angled wall extending into the feed chute and spaced inwardly from the feed chute to define a gap between the feed chute and the diffuser for intersecting the particles and directing the particles through the gap and for creating a curtain of particles about the base. An applicator is mounted adjacent the base of the diffuser for spraying the coating downwardly away from the diffuser and for treating the plurality of particles with the coating. An exit chute is disposed about the diffuser for capturing the treated particles. A flow control device is coupled to at least one of the feed chute and the diffuser for dynamically adjusting a size of the gap between the feed chute and the diffuser as the particles pass through the gap for maintaining a predetermined flow rate of the particles about the diffuser.

The subject invention also includes the associated method of treating the plurality of particles with the coating. The method comprises the steps of: feeding the plurality of particles into the feed chute; intersecting the particles with the diffuser to direct the particles through the gap and to create a curtain of particles falling about the diffuser; spraying the coating from the applicator downwardly away from the diffuser toward the exit chute in a predetermined pattern; intersecting the plurality of particles with the predetermined pattern of the coating for treating each of the particles with the coating; and dynamically adjusting a size of the gap between the feed chute and the diffuser as the particles pass through the gap for maintaining a predetermined flow rate of the particles about the diffuser.

Accordingly, the subject invention provides an apparatus and method for efficiently treating a large amount of particles with a minimal amount of coating and for ensuring that the particles maintain a predetermined flow rate and do not become clogged within the apparatus.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partial fragmentary side view of an apparatus incorporating the subject invention;

FIG. 2 is a partial fragmentary end view of the apparatus;

FIG. 3 is a partial fragmentary perspective view of a sub-assembly of the apparatus schematically illustrating a feed chute, the diffuser, an applicator, and an exit chute;

FIG. 4 is a partially cross-sectional schematic view of the sub-assembly with a single particle passing therethrough;

FIG. 5 is another partially cross-sectional schematic view of the sub-assembly with a plurality of particles passing therethrough;

FIG. 6 is a partially cross-sectional schematic view of an alternative sub-assembly of the apparatus having an outer chamber, the diffuser, the applicator, and a deflector;

FIG. 7 is a partially cross-sectional schematic view of a series of the sub-assemblies of FIG. 6;

FIG. 8 is a partially cross-sectional schematic view of another alternative embodiment of the sub-assembly wherein the diffuser is dynamically adjustable;

FIG. 9 is a partially cross-sectional view of the diffuser and feed chute illustrating various widthwise dimensions of the diffuser and a dynamic adjustment of the feed chute;

FIG. 10 is a partially cross-sectional schematic view of the diffuser and the feed chute having a bladder in an inflated position; and

FIG. 11 is a partially cross-sectional schematic view of the diffuser and the feed chute having the bladder in a deflated position.

### DETAILED DESCRIPTION OF THE INVENTION

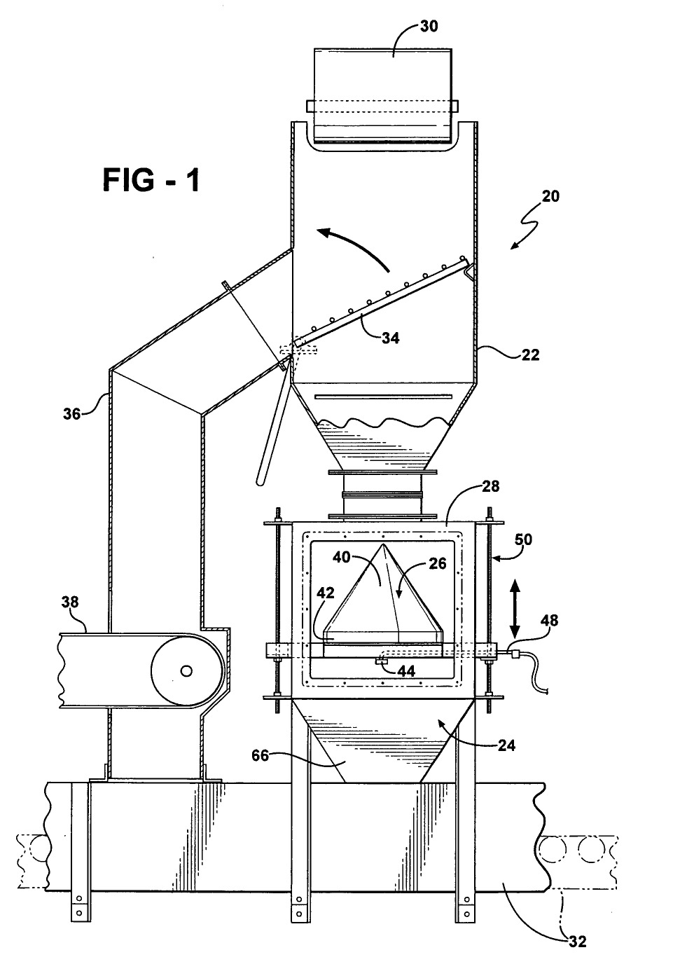

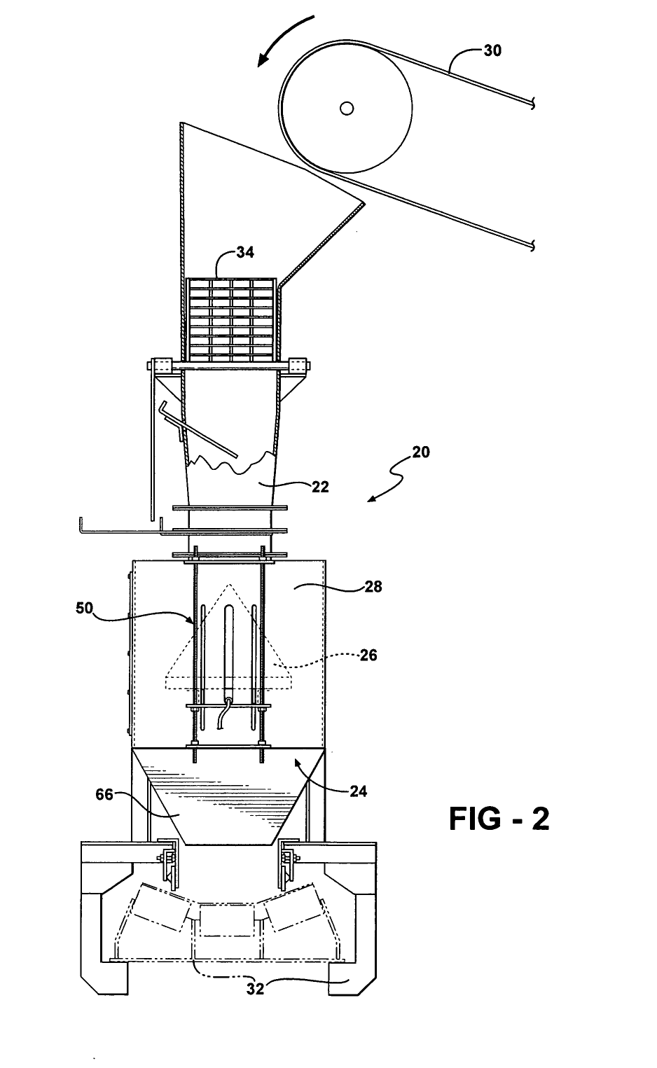

Referring to the Figures, wherein like numerals indicate like or corresponding parts throughout the several views, an apparatus in accordance with the subject invention is generally shown at 20 in FIGS. 1 and 2. The apparatus 20 includes a feed chute 22 and an exit chute 24. The feed chute 22 has an inlet for receiving particles and an outlet for discharging the particles (the particles are not shown in this Figure). The feed chute 22 is preferably configured as a hopper having angled walls at an inlet thereof. The exit chute 24 is discussed in greater detail below. A diffuser 26 is disposed between the feed 22 and exit 24 chutes. A feed conveyor 30 is preferably disposed over the feed chute 22 to provide a desired inflow of particles. An exit conveyor 32 is preferably disposed below the exit chute 24 to capture and transport treated particles as the particles are discharged from the apparatus 20. The feed chute 22, exit chute 24, and conveyors 30, 32 are know to those skilled in the art and may be of any suitable design or configuration.

A screen 34 can be mounted within the feed chute 22 for sifting the plurality of particles before the particles intersect the diffuser 26. The screen 34 has a plurality of openings of a predetermined size wherein any particles larger than this predetermined size cannot pass through the screen 34. As shown in FIG. 1, a bypass chute 36 is mounted to the feed chute 22 and is aligned with the screen 34 such that any particles larger than the predetermined size (as defined by the screen 34) are redirected into the bypass chute 36. A bypass conveyor 38 collects the particles larger than the predetermined size as the particles are discharged from the bypass chute 36.

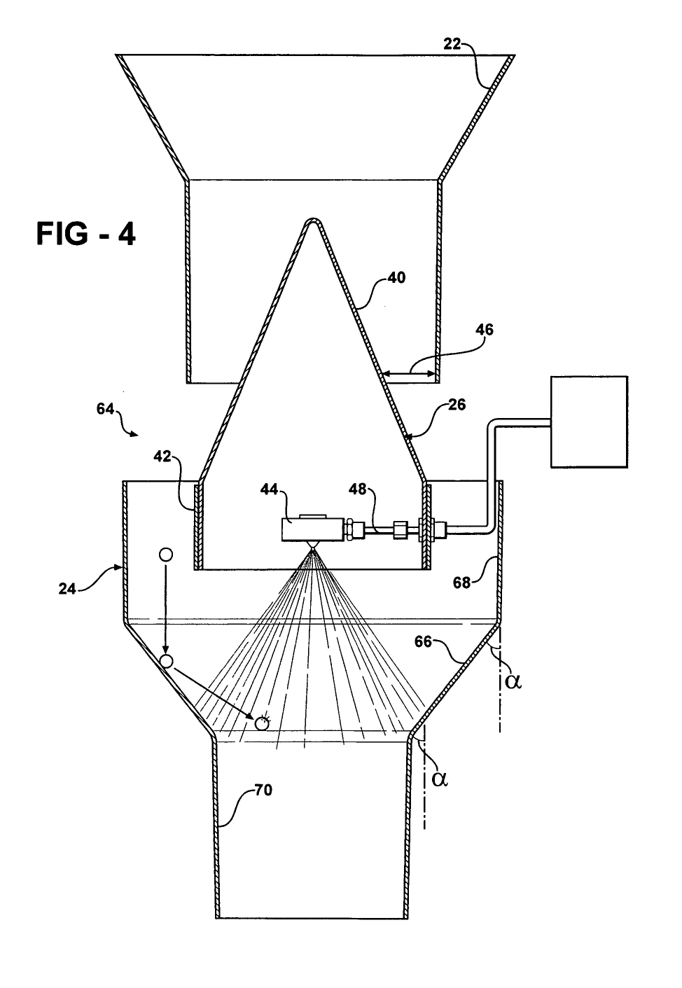

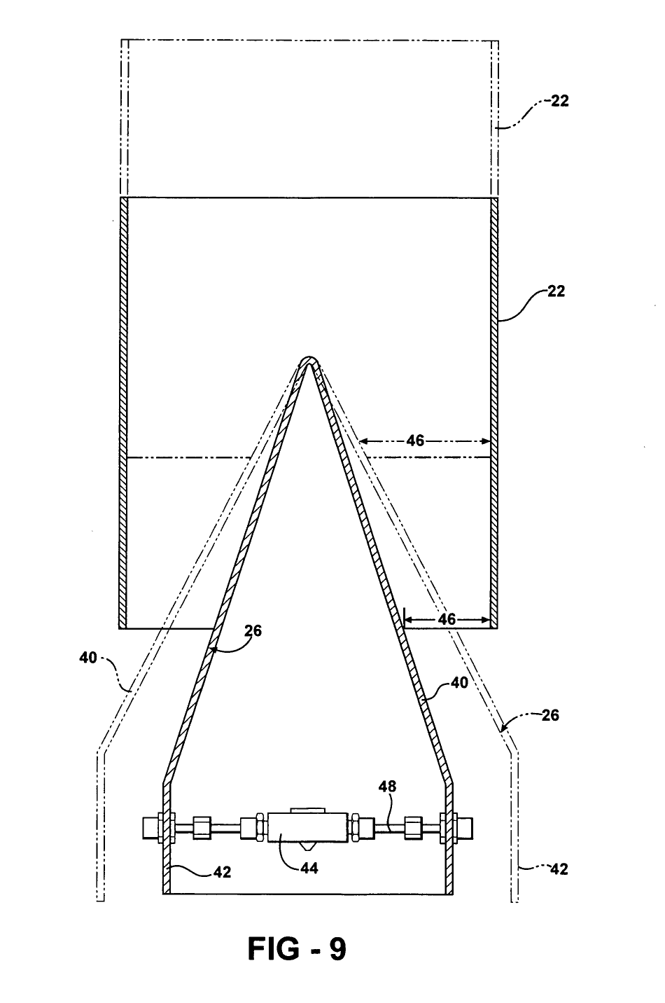

As shown in all of the Figures, the diffuser 26 includes an angled wall 40 and a base 42 to define a substantially cone shaped configuration. As shown in FIG. 9, the angled wall 40 of the diffuser 26 may be of any suitable slope. It should be appreciated that the diffuser 26 may be of any suitable configuration as is needed. As best shown in FIGS. 4-5 and 8-11, the angled wall 40 extends into the feed chute 22 and is spaced inwardly from the feed chute 22 to define a gap 46 between the feed chute 22 and the diffuser 26. The particles intersect the diffuser 26 and are directed through the gap 46. As will be discussed in greater detail below, a size of the gap 46 can be dynamically adjusted. There is a curtain of particles that is created about the base 42 as the particles fall off of the diffuser 26.

An applicator 44, or spray nozzle, is mounted adjacent to the base 42 of the diffuser 26 for treating the plurality of particles with a coating. The applicator 44 is preferably mounted centrally under the diffuser 26 to reduce the likelihood of damage or clogging from the particles. An inlet pipe 48 is connected to the applicator 44 to provide the requisite coating to the applicator 44. As discussed in greater detail below, the applicator 44 sprays the coating downwardly away from the diffuser 26. Applicators 44 that are suitable for the subject invention are well known in the art and will therefore not be discussed in any greater detail.

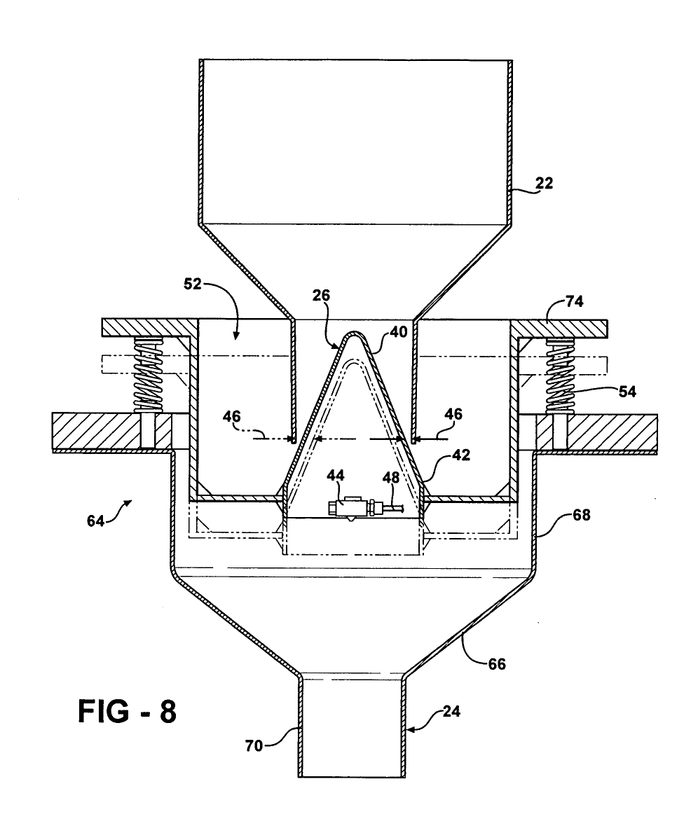

As shown in FIGS. 1 and 2, one embodiment of a diffuser housing 28 is shown. The diffuser housing 28 includes four walls forming a substantially box shaped structure with one of the walls having a window disposed therein. An adjustment mechanism 50 is coupled between the diffuser housing 28 and the diffuser 26 for adjusting a height of the diffuser 26 relative to the diffuser housing 28. Further, the adjustment mechanism 50 adjusts a height of the diffuser 26 relative to the feed chute 22 to define the desired gap 46 between the diffuser 26 and feed chute 22. In this embodiment, the height of the diffuser 26 is secured relative to the feed chute 22 prior to the operation of the apparatus 20. As eluded to above and discussed in greater detail below with reference to FIGS. 8-11, the size of the gap 46 is preferably adjustable in a dynamic manner.

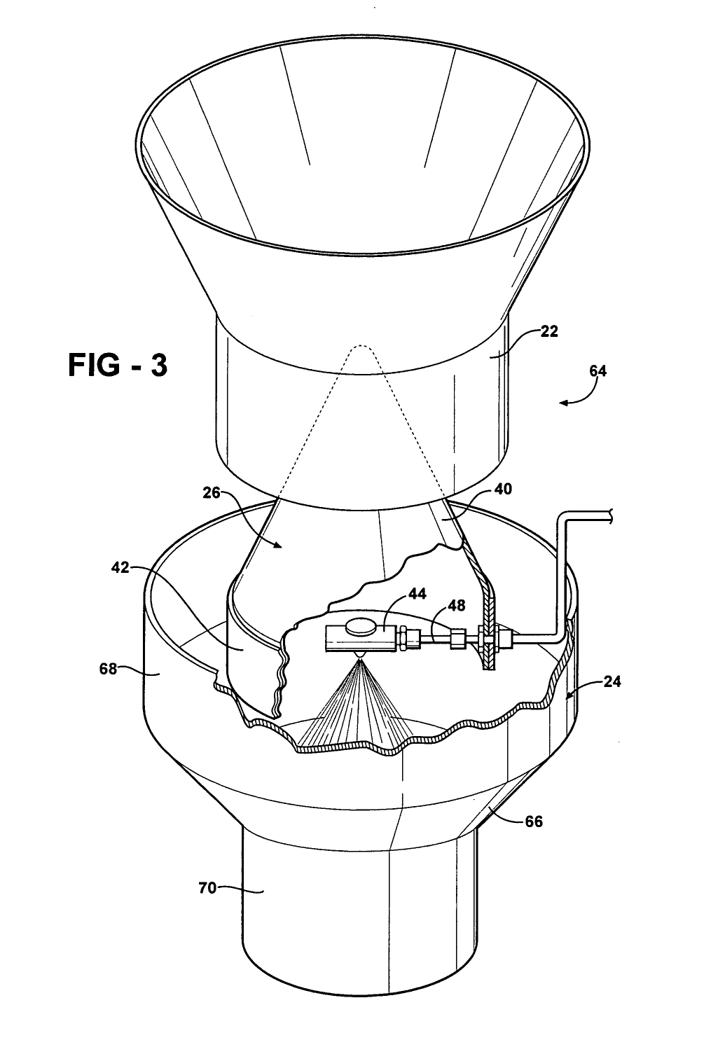

As shown in FIGS. 3-5, a sub-assembly of the apparatus 20 is schematically shown at 64. The sub-assembly 64 includes the feed chute 22, diffuser 26, applicator 44, and exit chute 24. In order to best illustrate some of the operational features of the invention, many of the mounting components are removed in these Figures such that this sub-assembly 64 is somewhat schematic in detail. In FIGS. 4-6, the applicator 44 is mounted to the base 42 of the diffuser 26 through the inlet pipe 48.

As best shown in FIGS. 1-2 and 3-5, the exit chute 24 is disposed about the diffuser 26 for capturing the treated particles. As with the feed chute 22, the exit chute 24 is preferably configured as hopper having angled walls at an inlet thereof. The exit chute 24 includes a deflector 66 disposed below the diffuser 26 and the applicator 44. The deflector 66 is angled in such a manner as to adequately redirect the particles without clogging the exit chute 24 or interfering with the operation of the applicator 44. Even more preferably, the deflector 66 cuts across the base 42 such that an entire curtain of particles falling from the base 42 will be redirected by the deflector 66.

In the embodiment of FIGS. 3-5, the exit chute 24 includes a capture portion 68 and a discharge portion 70 which is smaller in diameter than the capture portion 68. The deflector 66 is angularly positioned between the larger capture portion 68 and the smaller discharge portion 70. Preferably, the capture portion 68 of the exit chute 24 is positioned adjacent the diffuser 26 for positioning the deflector 66 adjacent the base 42. The deflector 66 may alternatively be mounted directly to the diffuser housing 28, such as shown in FIGS. 1 and 2.

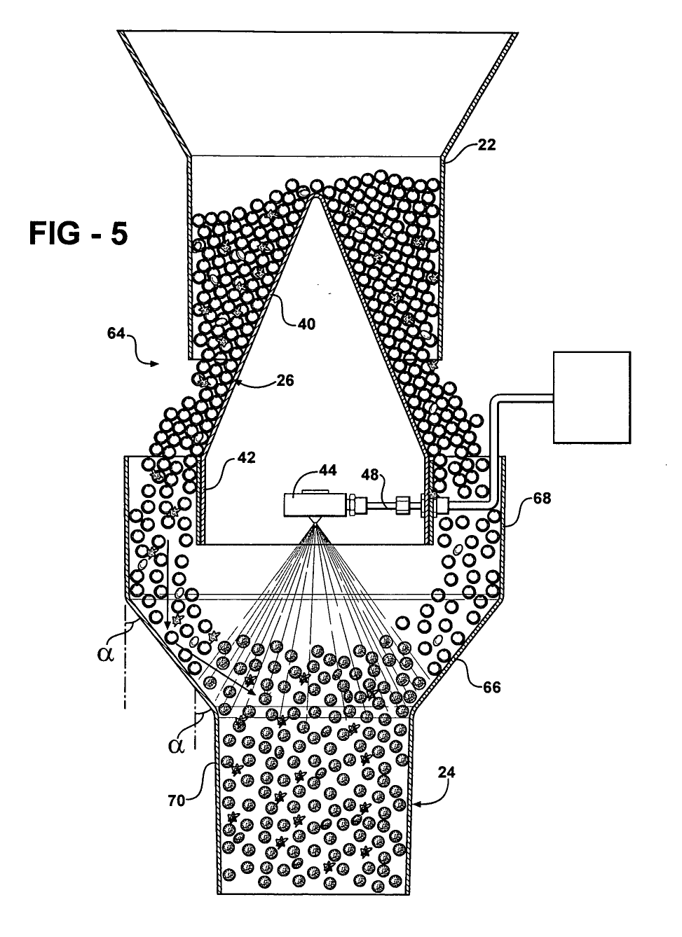

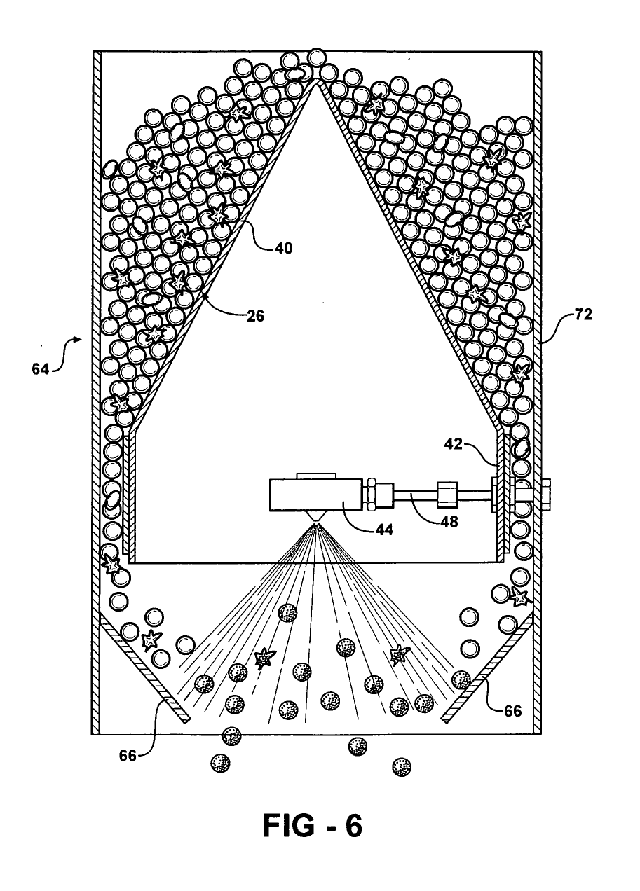

FIG. 5 illustrates a single particle passing through the sub-assembly 64 and FIG. 6 illustrates a plurality of particles passing through the sub-assembly 64. Preferably, the plurality of particles is further defined as a plurality of granules. It should be appreciated that the granules may any suitable product for virtually any industry. Examples of granules commonly used as fertilizers can include ammonium sulfate granules, ammonium nitrate granules, urea, calcium nitrate, mono-ammonium phosphate, di-ammonium phosphate isobutylidene diurea, urea reaction products such as urea-formaldehyde, and various complex fertilizers commonly called NPK. Examples of granules not associated with fertilizers include those used as powdered detergents, aggregates used in construction, surface treated minerals and various food substances such as hard candy. In addition, the granules can be in the shaped of spheres, ovals or any other suitable configuration.

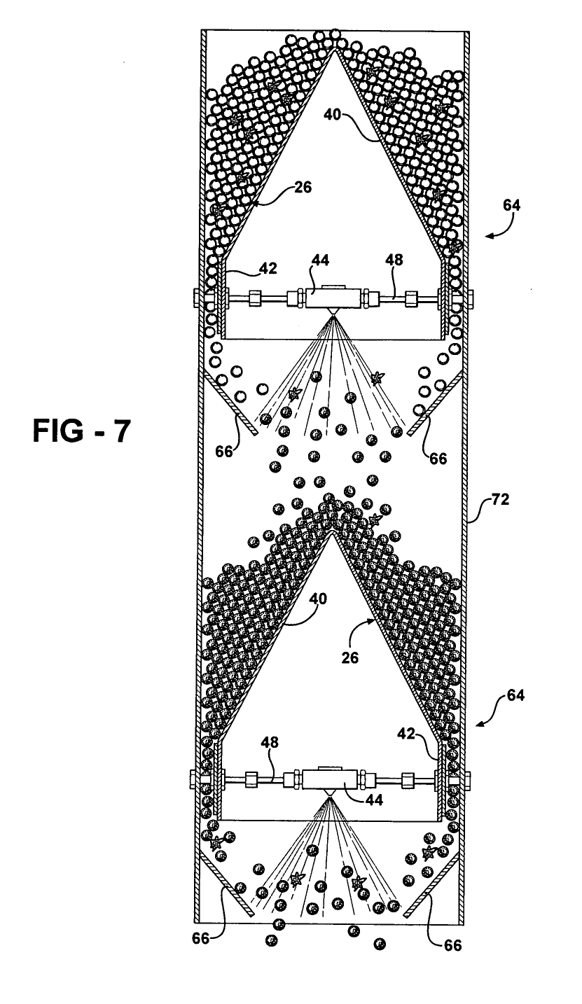

Referring to FIGS. 6 and 7, an alternative sub-assembly 64 of the apparatus 20 is generally shown. This alternative sub-assembly 64 incorporates a different structure to perform virtually the same efficient treating steps set forth above. In particular, the alternative sub-assembly 64 includes an outer chamber 72, the diffuser 26, the applicator 44, and an alternatively configured deflector 66. The outer chamber 72 can include the feed chute 22 and exit chute 24 and can be of any suitable length or configuration. Alternatively, the feed chute 22 and exit chute 24 can be disposed about the outer chamber 72 as separate components. The diffuser 26 and applicator 44 have virtually the same configuration. The deflector 66, however, is an angled wall 66 extending inwardly from the outer chamber 72. The configuration of the sub-assembly 64 shown in FIG. 6 can be stacked in series, such as shown in FIG. 7, to increase the coverage percentage of the particles, if desired.

Turning to FIGS. 8-11, the dynamic adjustment of the gap 46 between the feed chute 22 and the diffuser 26 is now addressed in detail. A flow control device 52 is coupled to at least one of the feed chute 22 and the diffuser 26 for dynamically adjusting the size of the gap 46 between the feed chute 22 and the diffuser 26. This dynamic adjustment is preferably performed as the particles pass through the gap 46. The dynamic adjustment of the size of the gap 46 maintains a predetermined flow rate of the particles about the diffuser 26 and ensures that the gap 46 does not become clogged with particles. There are various illustrated embodiments of the flow control device 52 for dynamically adjusting the size of the gap 46, which are discussed individually below. For example, the flow control device 52 could move the diffuser 26 relative to the feed chute 22 for adjusting the size of the gap 46. Alternatively, the flow control device 52 could move the feed chute 22 relative to the diffuser 26 for adjusting the size of the gap 46. Further, the flow control device 52 could change a volumetric size of one of the feed chute 22 and the diffuser 26 relative to the other of the diffuser 26 and the feed chute 22 for adjusting the size of the gap 46. It should be appreciated that these embodiments are merely representative of some contemplated embodiments and the flow control device 52 may be of any suitable configuration so long as the size of the gap 46 between the feed chute 22 and the diffuser 26 can be adjusted.

As shown in FIG. 8, the flow control device 52 is mounted to the diffuser 26 for dynamically or automatically moving the diffuser 26 relative to the feed chute 22. The flow control device 52 includes a support plate 74 with one end of the support plate 74 mounted to the diffuser 26 and an opposing end of the support plate 74 movably mounted to the exit chute 24 for dynamically coupling the diffuser 26 to the exit chute 24. The diffuser 26 moves vertically relative to both the feed 22 and exit 24 chutes along a central axis defined by the feed chute 22 and the diffuser 26. A spring mechanism 54 is disposed between the opposing end of the support plate 74 and the exit chute 24 for continuously biasing the diffuser 26 toward the feed chute 22. The momentum and weight of the particles against the diffuser 26 will automatically move the diffuser 26 downwardly relative to the feed chute 22 to provide the requisite gap 46 between the diffuser 26 and the feed chute 22.

FIG. 9 illustrates the dynamic or automatic movement of the feed chute 22 relative to the diffuser 26. In other words, the feed chute 22 can move upwardly and downwardly to define the desired gap 46 between the feed chute 22 and the diffuser 26. The upward and downward movement of the feed chute 22 can be accomplished through any suitable mechanism.

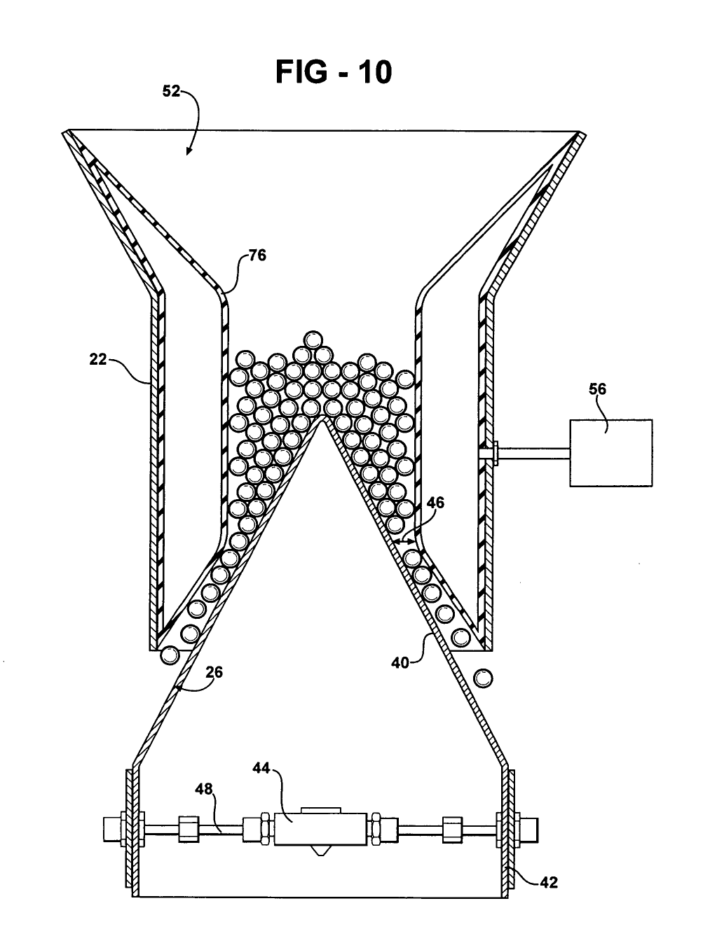

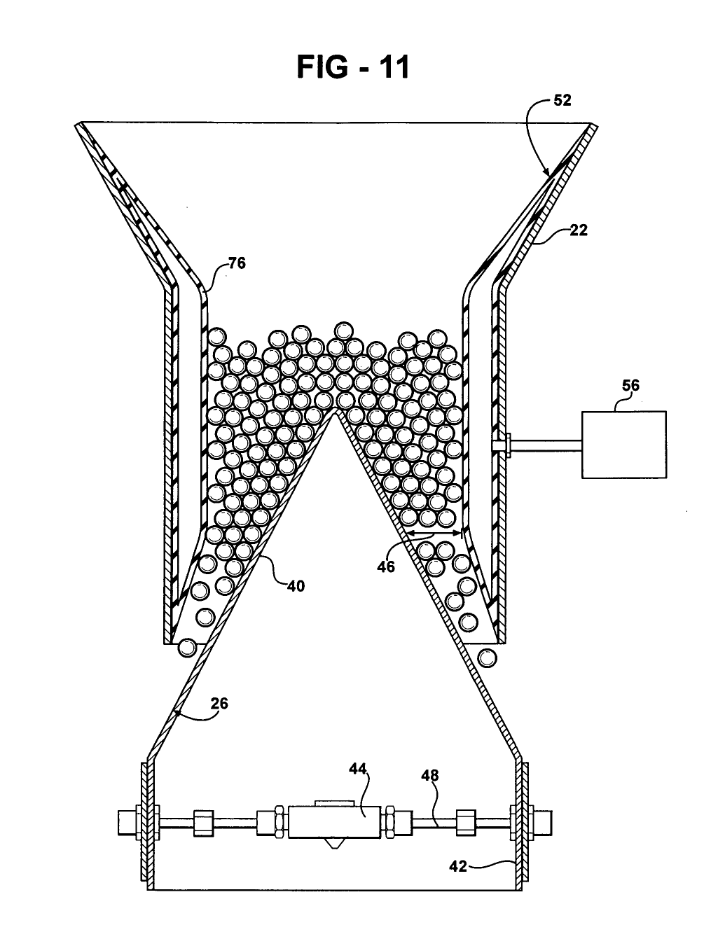

Turning to FIGS. 10 and 11, the flow control device 52 is mounted to the feed chute 22 for changing the volumetric size of the feed chute 22. Preferably, the flow control device 52 includes a flexible bladder 76 mounted to the feed chute 22 with the bladder 76 expanding and deflating for adjusting the size of the gap 46. The bladder 76 may be mounted to an inner wall of the feed chute 22 to define the gap 46 between the feed chute 22 and the diffuser 26. The bladder 76 may have a continuous substantially donut shaped configuration or may be of a discontinuous configuration. Further, the bladder 76 can include sloped ends of any suitable angle. As shown in FIG. 10, the bladder 76 may be inflated to define a relatively narrow gap 46 or, as shown in FIG. 11, the bladder 76 may be deflated to define a larger gap 46 between the feed chute 22 and the diffuser 26. A fluid regulator 56 is fluidly connected to the bladder 76 to allow inflation or deflation of the bladder 76 as desired. Preferably, the fluid regulator 56 provides air for the bladder 76.

The particular method steps of treating the plurality of particles with the coating will now be discussed in detail. Initially, the plurality of particles are fed into the feed chute 22 from the feed conveyor 30. The particles from the outlet of the feed chute 22 intersect the diffuser 26 to direct the particles through the gap 46 and to create a curtain of particles falling about the diffuser 26. Preferably, the particles intersect the angled wall 40 extending into the feed chute 22.

The size of the gap 46 between the feed chute 22 and the diffuser 26 is dynamically adjusted as the particles pass through the gap 46. The dynamic or automatic adjustment maintains a predetermined flow rate of the particles about the diffuser 26 and ensures that the gap 46 does not become clogged with particles. As also discussed above, the adjustment of the size of the gap 46 can be accomplished in a variety of different ways. In the embodiment of FIG. 8, the diffuser 26 is dynamically moved relative to the feed chute 22 to adjust the size of the gap 46. The dynamic adjustment of the size of the gap 46 can include the step of continuously biasing the diffuser 26 toward the feed chute 22. A force generated by the particles is applied to the diffuser 26 against the biasing of the diffuser 26 toward the feed chute 22. The force moves the diffuser 26 away from the feed chute 22 to dynamically adjust the size of the gap 46. In other words, the force of the particles overcome the biasing of the spring mechanism 54 to define the size of the gap 46. The force of the particles can be from a flow rate of the particles, a momentum carried by the particles, a weight of the particles or a combination thereof. As the force increases or decreases, which can be by an increase or decrease in the flow of particles for example, the pressure of the particles on the diffuser 26 changes to cause the diffuser 26 to move relative to the feed chute 22 thereby adjusting the size of the gap 46.

Alternatively, as shown in FIG. 9, the feed chute 22 can move dynamically relative to the diffuser 26 to adjust the size of the gap 46. Further, as shown in FIGS. 10 and 11, a volumetric size of one of the feed chute 22 and the diffuser 26 can be dynamically changed relative to the other of the diffuser 26 and the feed chute 22 to adjust the size of the gap 46. Preferably, the volumetric size of the feed chute 22 is dynamically changed by the force of the particles against the bladder 76. As the force increases or decreases, the pressure of the particles on the bladder 76 will increase or decrease, which will push the bladder 76 outward to deflate the bladder 76 or allow the bladder 76 to inflate, thereby adjusting the size of the gap 46.

Regardless of the embodiment or the design of the flow control device 52, the plurality of particles pass about the diffuser 26 and through the gap 46 at a high throughput rate such that the subject invention can efficiently treat a large volume of particles in a relatively short period of time without clogging the apparatus. It should be appreciated that the speed of the particles passing through the apparatus 20 can vary depending upon the type of particle and particle size. Further, atmospheric conditions can alter the flow rate of the particles. One non-limiting example includes the throughput of the particles passing through the feed chute 22 and about the diffuser 26 at a rate of 200 to 40,000 lbs per hour.

The coating is sprayed from the applicator 44 downwardly away from the diffuser 26 toward the exit chute 24 in a predetermined pattern. In the embodiment illustrated, the coating is sprayed downwardly in a cone shaped pattern defining an outer periphery of the sprayed coating. It should be appreciated that the coating could be sprayed in alternative patterns.

The curtain of particles falling from the base 42 of the diffuser 26 are captured by the exit chute 24. The plurality of particles intersect the predetermined pattern of the coating for treating each of the particles with the coating. In the illustrated embodiment, the particles intersect with the deflector 66 to redirect the particles into the predetermined pattern of the coating for treating each of the particles with the coating.

The coating can be sprayed in a relatively low throughput rate in comparison to the high throughput rate of particles passing through the apparatus 20. Again, it should be appreciated that the coating may be sprayed at any suitable rate without deviating from the overall scope of the subject invention. In one non-limiting example, the coating can be sprayed at a rate of 15 to 80 lbs per hour. Preferably, at least twenty five percent of the particles intersecting the deflector are treated during the process. As non-limiting examples, it has been found that less than fifty percent of ammonium sulfate particles need to be covered to prevent anti-caking of these particles. As another non-limiting example, it has been found that nearly one-hundred percent of ammonium nitrate particles need to be covered to prevent anti-caking of these particles. It should be appreciated, that the percent of coverage for the particles is dependent upon the type of particle, size of the particle, atmospheric conditions, as well as a number of other factors. Hence, the percent of coverage can vary greatly without deviating from the overall scope of the subject invention. The subject invention therefore defines an efficient method treating a large amount of particles with a minimal amount of coating.

The treated particles are then discharged out of the exit chute 24 and accumulate along the exit conveyor 32. As discussed above, particles that exceed a predetermined size will be re-routed down a bypass chute 36 to a bypass conveyor 38.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims the invention may be practiced otherwise than as specifically described.

What is claimed is:

1. An apparatus for treating a plurality of particles with a coating, said apparatus comprising;
a feed chute having an inlet for receiving the particles and an outlet for discharging the particles,
a diffuser having an angled wall and a base with said angled wall extending into said feed chute and spaced inwardly from said feed chute to define a gap between said feed chute and said diffuser for intersecting the particles and directing the particles through said gap and for creating a curtain of particles about said base,
an applicator mounted adjacent said base of said diffuser for spraying the coating downwardly away from said diffuser and for treating the plurality of particles with the coating,
an exit chute disposed about said diffuser for capturing the treated particles, and
a flow control device coupled to at least one of said feed chute and said diffuser for dynamically adjusting a size of said gap between said feed chute and said diffuser as the particles pass through said gap for maintaining a predetermined flow rate of said particles about said diffuser.

2. An apparatus as set forth in claim 1 wherein said flow control device moves said diffuser relative to said feed chute for adjusting said size of said gap.

3. An apparatus as set forth in claim 2 wherein said flow control device is mounted to said diffuser at one end for moving said diffuser along a central axis defined by said feed chute and said diffuser.

4. An apparatus as set forth in claim 3 wherein said flow control device is movably mounted to said exit chute at an opposing end for dynamically coupling said diffuser to said exit chute.

5. An apparatus as set forth in claim 4 wherein said flow control device includes a spring mechanism disposed between said opposing end of said flow control device and said exit chute for continuously biasing said diffuser toward said feed chute.

6. An apparatus as set forth in claim 1 wherein said flow control device moves said feed chute relative to said diffuser for adjusting said size of said gap.

7. An apparatus as set forth in claim 1 wherein said flow control device changes a volumetric size of one of said feed chute and said diffuser relative to the other of said diffuser and said feed chute for adjusting said size of said gap.

8. An apparatus as set forth in claim 7 wherein said flow control device is mounted to said feed chute for changing said volumetric size of said feed chute.

9. An apparatus as set forth in claim 8 wherein said flow control device includes a flexible bladder mounted to said feed chute with said bladder expanding and deflating for adjusting said size of said gap.

10. An apparatus as set forth in claim 9 wherein said flow control device includes a fluid regulator fluidly connected to said bladder.

11. An apparatus as set forth in claim 1 wherein said angled wall of said diffuser defines a substantially cone-shaped configuration

12. An apparatus as set forth in claim 11 wherein said applicator is mounted centrally under said cone-shaped diffuser.

13. A method of treating a plurality of particles with a coating utilizing an apparatus having a feed chute, a diffuser disposed adjacent the feed chute defining a gap between the feed chute and the diffuser, an applicator, and an exit chute; said method comprising the steps of:
feeding the plurality of particles into the feed chute;
intersecting the particles with the diffuser to direct the particles through the gap and to create a curtain of particles falling about the diffuser;
spraying the coating from the applicator downwardly away from the diffuser toward the exit chute in a predetermined pattern;
intersecting the plurality of particles with the predetermined pattern of the coating for treating each of the particles with the coating; and
dynamically adjusting a size of the gap between the feed chute and the diffuser as the particles pass through the gap for maintaining a predetermined flow rate of the particles about the diffuser.

14. A method as set forth in claim 13 wherein the step of dynamically adjusting the size of the gap includes the step of dynamically moving the diffuser relative to the feed chute to adjust the size of the gap.

15. A method as set forth in claim 14 wherein the step of dynamically adjusting the size of the gap includes the step of continuously biasing the diffuser toward the feed chute.

16. A method as set forth in claim 15 wherein the step of dynamically adjusting the size of the gap includes the step of applying a force to the diffuser generated by the particles against the biasing of the diffuser toward the feed chute.

17. A method as set forth in claim 13 wherein the step of dynamically adjusting the size of the gap includes the step of dynamically moving the feed chute relative to the diffuser to adjust the size of the gap.

18. A method as set forth in claim 13 wherein the step of dynamically adjusting the size of the gap includes the step of dynamically changing a volumetric size of one of the feed chute and the diffuser relative to the other of the diffuser and the feed chute to adjust the size of the gap.

19. A method as set forth in claim 18 wherein the step of dynamically adjusting the size of the gap includes the step of dynamically changing the volumetric size of the feed chute.

20. A method as set forth in claim 13 further including the step of accumulating the treated particles onto a conveyor.
